(19) United States
(12) Patent Application Publication
(10) Pub. No.: US 2025/0363776 A1
(43) Pub. Date: Nov. 27, 2025

(54) AUTOMATED MEDIA CONTENT RECOGNITION FOR UNDERSTANDING MULTIMEDIA

(71) Applicant: NVIDIA Corporation, Santa Clara, CA (US)

(72) Inventors: Parthasarathy Sriram, Los Altos Hills, CA (US); Farzin Aghdasi, East Palo Alto, CA (US); Arun George Zachariah, San Jose, CA (US); Varun Praveen, Cupertino, CA (US)

(21) Appl. No.: 18/673,972

(22) Filed: May 24, 2024

(51) Int. Cl. G06V 10/764; G06F 40/20; G06V 10/26; G06V 10/82

(52) U.S. Cl. CPC G06V 10/764; G06F 40/20; G06V 10/26; G06V 10/82

(57) ABSTRACT

Disclosed are apparatuses, systems, and techniques for automated content recognition with custom computing code generation using language models. The techniques include obtaining a first prompt for a description of a media item, processing, using a content detection model, the media item and a representation of the first prompt to obtain a characterization of the media item. The techniques further include generating, using the first prompt and the characterization of the media item, a second prompt that includes an instruction to a language model (LM). The techniques further include causing the LM to process the second prompt to generate a computing code associated with the characterization of the media item, and causing the computing code to be executed to generate the responsive description of the media item.

### TECHNICAL FIELD

At least one embodiment pertains to content generation using artificial intelligence (AI) systems. For example, at least one embodiment pertains to AI systems and techniques for recognizing media content and representing the understanding of the recognized content in a natural language form.

### BACKGROUND

Well-trained language models—such as large language models (LLMs)—are capable of supporting conversations in natural language, understanding speaker intents and emotions, explaining complex topics, generating new texts upon receiving suitable prompts, providing recommendations regarding topics of interest to a user, processing image, audio, and/or other data types, and/or performing other functions. LLMs typically undergo self-supervised training on massive amounts of text data and/or other data types, depending on the embodiment, and learn to predict next and/or missing tokens (which may correspond to sub-words, symbols, words, etc.) in a phrase/sentence, detect intent and/or sentiment of a human speaker, determine if two sentences are related or unrelated, and/or perform other basic language tasks. Following the initial training, LLMs often undergo instructional (prompt-based) supervised fine-tuning that causes LLMs to acquire more in-depth language proficiency and/or master more specialized tasks. Supervised fine-tuning includes using learning prompts (questions, hints, etc.) that are accompanied by example texts (e.g., answers, sample essays, etc.) serving as training ground truth. In reinforcement fine-tuning, a human evaluator assigns grades indicative of a degree to which the generated text resembles human-produced texts.

### BRIEF DESCRIPTION OF DRAWINGS

FIG. 1 is a block diagram of an example computer architecture capable of automated content recognition and custom computing code generation using language models, according to at least one embodiment;

FIG. 2 illustrates an example computing device that supports deployment of systems facilitating automated content recognition with custom computing code generation using language models, according to at least one embodiment;

FIG. 3 illustrates an example data flow of automated content recognition with generation of custom computing codes using language models, according to at least one embodiment;

FIG. 4 illustrates an example architecture of an open vocabulary content detection model that can be used for automated content recognition with custom computing code generation, according to at least one embodiment;

FIGS. 5A-5B illustrate schematically content detection that can be used with custom computing code generation, according to at least one embodiment;

FIG. 6 is a flow diagram of an example method of automated content recognition with custom computing code generation using language models, according to at least one embodiment;

FIG. 7A illustrates inference and/or training logic, according to at least one embodiment;

FIG. 7B illustrates inference and/or training logic, according to at least one embodiment;

FIG. 8 illustrates training and deployment of a neural network, according to at least one embodiment;

FIG. 9 is an example data flow diagram for an advanced computing pipeline, according to at least one embodiment; and

FIG. 10 is a system diagram for an example system for training, adapting, instantiating and deploying machine learning models in an advanced computing pipeline, according to at least one embodiment.

### DETAILED DESCRIPTION

Computer vision AI provides computers with ability to detect various objects of interest in images and videos, e.g., people, animals, cars, etc., actions and events, e.g., sporting actions, gaming actions, occurrences of certain anticipated or unexpected acts and/or conditions, e.g., traffic jams, unsafe or undesired manufacturing conditions, and/or the like. Computer vision (CV) automates tasks conventionally performed by human observers. An output of a CV model can include localization of objects (e.g., using bounding boxes or other segmentation techniques), classifications of the objects (e.g., by a type or class among a number of classes learned in training), degree of confidence in the obtained localizations/classifications, and/or the like. Such outputs can be used by downstream systems, e.g., on-board planners of autonomous vehicles.

Vision language models combine CV functionality with that of language models for natural language (NL) understanding of data and/or tasks to be performed on the data. For example, a prompt to a vision language model (e.g., “is the animal in the image a cat or a dog?”) can ask for classification of object(s), and an output can include a set of classes and probabilities (e.g., “cat, 0.8; dog, 0.1”). In some instances (e.g., as in the above example), the outputs can be easily understood by humans, including laypeople. In more complex situations (e.g., “how many pedestrians are crossing the road in this video?”), the user may have to perform some additional analysis of the outputs, e.g., sift through various bounding boxes and classifications generated by the model and manually identify relevant objects. Alternatively, a developer can write a custom post-processing code that parses the outputs and extracts actionable data to produce a response to the user's query (e.g., “five pedestrians are crossing the road”). Writing such codes requires at least some coding experience that most non-specialists lack or may be impractical or cost ineffective in situations where many different tasks need to be processed. For example, a code that aims to extract information about “how many bags a passenger in the blue shirt carries?” can be quite different—and therefore written separately—from a code created to determine whether locations and positions of cars within an image indicate that a traffic accident has occurred.

Aspects and embodiments of the present disclosure address these and other challenges of the vision language technology by providing for systems and techniques that automate content recognition and generate custom computing codes using language models with no expert coder involvement. In some embodiments, a user prompt (query, question, etc.) may undergo keyword extraction that identifies a type of a target content in a media data (e.g., objects present in an image/video or an audio file). Based on the identified keywords, a content detection model (e.g., a CV model) may be selected from an available repository of the models. In those instances where one or more models are available for detection of specific target content of interest (e.g., trained pedestrians-detection models), such specialized model(s) may be used. In those instances, where no trained models are available for detection of the target content, one or more open vocabulary content detection models may be selected. An open vocabulary model may include a media-processing portion (e.g., an object detection portion) and a pre-trained language-comprehension portion that are—jointly—capable of detecting content not previously encountered (e.g., in training) by the media-processing portion. In particular, an open vocabulary model leverages its language-comprehension abilities to identify features of previously unseen object(s). For example, the media-processing portion may have never encountered an image of a lion, but the language-comprehension portion may have consumed a number of texts describing lions including information of lions being big felines with large heads, rounded ears, brown-to-yellow color, with grown male lions typically having a thick mane, and/or other information. Correlations between the two portions of the model cause the language descriptions of features of the target object to propagate to the vision neurons of the model and facilitate recognition of unfamiliar target objects.

The content detection model may generate information that is pertinent to the target content, e.g., bounding boxes and object types for target objects referenced in the model inputs (e.g., keywords derived from user prompts). The user prompt may then be augmented with the content detection outputs and the code-writing instructions (e.g., “write a script to count how many times Y is present in [the content detection outputs].” The augmented prompt may further include instructions (explanations) how to understand the format of the detection outputs. The augmented prompt may then be used as an input into an instructional language model (LM) trained to generate computing codes. The instructional LM processes the received prompt and generates a code (e.g., a Python code, a C++ code, a JavaScript code, and/or the like) capable of extracting the target information requested in the user prompt and contained in the content detection model outputs. For example, the LM can assemble a list of operators that include instructions on how to fetch data from the model outputs and compute instructions on how to process the fetched data. The source code generated by the instructional LM may be compiled, e.g., using a suitable compiler translating the source code into a machine code, and then executed to generate a response. The output of the code may include a natural language phrase or sentence, e.g., “X pedestrians are crossing the road” with the value X computed and substituted during the code execution.

The advantages of the disclosed embodiments include, but are not limited to, elimination of manual code writing by offloading this task to an instructional coding LM. The deployed techniques allow a developer to provide a single set of descriptions—per content detection model—to inform the instructional LM how to read the models' outputs. The prompts to the instructional LM may subsequently be generated fully automatically, based on received user prompts, with no need to manually generate separate task-dependent codes. The disclosed techniques improve the speed and versatility of applications of vision language systems and facilitate the use of such systems by non-expert users.

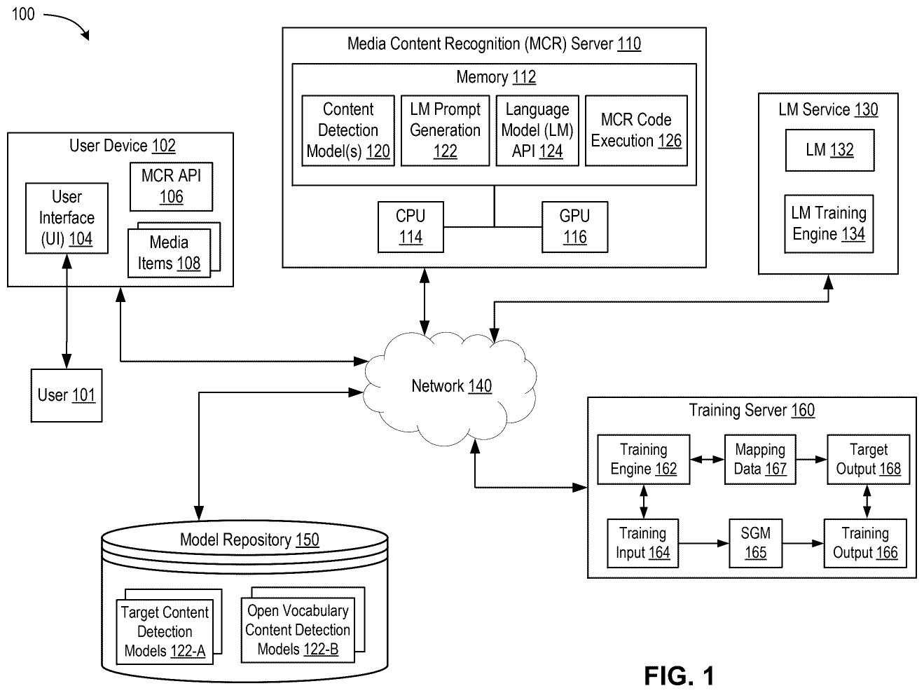

FIG. 1 is a block diagram of an example computer architecture 100 capable of automated content recognition and custom computing code generation using language models, according to at least one embodiment. As depicted in FIG. 1, computer architecture 100 may include a user device 102, a media content recognition (MCR) server 110, an LM service 130, a model repository 150, a training server 160, where any, some, or all of which may be connected via a network 140. Network 140 may be a public network (e.g., the Internet), a private network (e.g., a local area network (LAN), or wide area network (WAN)), a wireless network, a personal area network (PAN), a combination thereof, and/or another network type.

User device 102 may include a desktop computer, a laptop computer, a smartphone, a tablet computer, a server, a wearable device, a virtual/augmented/mixed reality headset or head-up display, a digital avatar or chatbot kiosk, an in-vehicle infotainment computing device, and/or any other suitable computing device capable of performing the techniques described herein. User device 102 may be configured to communicate with user 101 via user interface (UI) 104. User 101 may be an individual user (e.g., an owner of a computer, vehicle, entertainment equipment), a collective user (e.g., a business organization, an institution, a government agency, and/or the like), an agent of a repair facility, and/or the like. In some embodiments, prompts generated by user 101 may include a text (e.g., a sequence of one or more typed words), a speech (e.g., a sequence of one or more spoken words), an image, a gesture(s), and/or some combination thereof. The prompts may be generated as part of interaction of user 101 with MCR server 110 that uses LM service 130.

UI 104 may include one or more devices of various modalities, e.g., a keyboard, a touchscreen, a touchpad, a writing pad, a graphical interface, a mouse, a stylus, and/or any other pointing device capable of selecting words/phrases that are displayed on a screen, and/or some other suitable device. In some embodiments, UI 104 may include an audio device, e.g., a combination of a microphone and a speaker, a video device, such as a digital camera to capture an image or a sequence of two or more images (video frames), or both. In some embodiments, text, speech, and/or video input devices may be integrated together (e.g., into a smartphone, tablet computer, desktop computer, and/or the like).

In some embodiments, MCR server 110 may be located on one or more computing devices/servers, e.g., on a cloud-based server. User device 102 may download an MCR Application Programming Interface (API) 106 from MCR server 110 and deploy MCR API 106 to facilitate communications with MCR server 110. MCR server 110 may perform processing of prompts generated by user 101. The prompts may be natural language prompts directed to instruct MCR server 110 to detect and analyze content of one or more media items 108, for example, provided by user 101. Media items 108 may include image(s), video(s) (e.g., temporally, visually, and/or contextually related sequences of images/frames), audio(s), and or any other data items produced by suitable sensor(s), including but not limited to lidar sensors, radar sensors, infrared camera sensors, temperature sensors, pressure sensors, and/or any other physical or chemical sensors. MCR server 110 may process media items 108, e.g., as directed by user prompts. In some embodiments, processing of media items 108 by MCR server 110 may be facilitated by LM 132 provided by LM service 130.

In some embodiments, MCR server 110 may include a memory 112 (e.g., one or more memory devices or units) communicatively coupled to one or more processing devices, such as one or more central processing units (CPU) 114, one or more graphics processing units (GPU) 116, one or more data processing units (DPU), one or more parallel processing units (PPUs), and/or other processing devices (e.g., field-programmable gate arrays (FPGAs), application-specific integrated circuits (ASICs), and/or the like). Memory 112 may include a read-only memory (ROM), a flash memory, a dynamic random-access memory (DRAM), such as synchronous DRAM (SDRAM), a static memory, such as static random-access memory (SRAM), and/or some other memory capable of storing digital data. Memory 112 may store one or more content detection models 120 trained to detect and/or classify content of media items 108, an LM prompt generation module 122 to generate a prompt requesting LM 132 to write a computing code capable of processing outputs of the content detection model(s), an LM API 124 to facilitate communications with LM 132, and an MCR code execution module 126 to execute (and compile, if applicable) codes generated by LM 132. MCR server 110 may further support any number of additional components and modules not shown explicitly in FIG. 1, such as any applications capable of generating, displaying processing, editing, and/or otherwise using text data, audio data, image data, video data, and/or the like. In some embodiments, MCR server 110 may also be operated by LM service 130. Although depicted as separate from LM service 130 in FIG. 1, in some embodiments, MCR server 110 may host the LM 132.

In some embodiments, LM 132 may be a large language model, e.g., a model with at least 100K of learnable parameters, provided by LM service 130. LM 132 may be trained by LM training engine 134. In some embodiments, LM 132 may be a model that has been pretrained and deployed by a separate entity. In some embodiments, LM 132 may be trained in multiple stages. Initially, LM training engine 134 may train LM 132 to capture syntax and semantics of human language, e.g., by training to predict a next, a previous, and/or a missing word in a sequence of words (e.g., one or more sentences of a human speech or text). For example, LM 132 may be trained using training data containing a large number of texts, such as human dialogues, newspaper texts, magazine texts, book texts, web-based texts, and/or any other texts. Since ground truth (e.g., next words) for such training is embedded in the texts themselves, LM training engine 164 may use these texts for self-supervised training of LM 132. This teaches LM 132 to carry out a conversation with a user (a human user or another computer) in a natural language in a manner that closely resembles a dialogue with a human speaker, including understanding the user's intent and responding in ways that the user expects from a conversational partner.

Following the initial self-supervised training, LM training engine 134 may implement a supervised fine-tuning or instruction fine-tuning of LM 132 to teach LM 132 more specialized skills, including expertise in writing computer codes for various computational tasks, which may be formulated using natural language. In some embodiments, LM training engine 134 may facilitate any, some, or all stages of training of LM 132. For example, LM training engine 134 may oversee self-supervised training stage, focused on development of general language proficiency, and then pass pretrained LM 132 to another entity for additional fine-tuning of LM 132. In some instances, LM 132 may receive a pretrained LM 132 from another entity and perform fine-tuning of LM 132. In some instances, LM training engine 134 may perform both pretraining of LM 132 and field-specific fine-tuning of LM 132.

Content detection models 120 may be trained to identify specific target content (as may be named in a prompt) in any associated input data (e.g., media items 108), e.g., detect target objects in image/video frames, target words or descriptions in audio files, occurrences of specific conditions in sensor data, and/or the like. Content detection models 120 can be stored in model repository 150 and downloaded and deployed on MCR server 110. Models available in model repository 150 may include target content detection models 122-A, which may include models trained to detect content of specific types/classes of interest, e.g., cars, trucks, buses, pedestrians, bicyclists, and/or other objects. Such models may have a fixed number of output channels associated with the target classes. Additionally, models in model repository 150 may store open vocabulary content detection models 122-B, which may be trained to detect content of a certain number of type but also be capable of detecting objects not encountered in training, e.g., by leveraging language-comprehension abilities learned from a wide variety of texts that include descriptions of numerous content items, including many items whose images (or other representations) have not been seen by the models.

Training of content detection models 120 may be performed by training server 160, in some embodiments. In at least one embodiment, any, some, or all content detection models 120 may be implemented as deep learning neural networks having multiple layers of linear or non-linear operations. For example, any, some, or all content detection models 120 may include convolutional neural networks, recurrent neural networks, fully-connected neural networks, long short-term memory (LSTM) neural networks, neural networks with attention, e.g., transformer neural networks, and/or the like. In at least one embodiment, any, some, or all content detection models 120 may include multiple neurons, an individual neuron receiving its input from other neurons and/or from an external source and producing an output by applying an activation function to the sum of inputs modified by (trainable) weights and a bias value. In at least one embodiment, any, some, or all content detection models 120 may include multiple neurons arranged in layers, including an input layer, one or more hidden layers, and/or an output layer. Neurons from adjacent layers may be connected by weighted edges. In some embodiments, different content detection models may have different architecture, a number of neuron layers, a number of neurons in various layers, and/or the like.

Any, some, or all content detection models 120 may be trained by training engine 162 hosted by training server 160, which may be (or include) a desktop computer, a laptop computer, a smartphone, a tablet computer, a server, and/or any suitable computing device capable of performing the techniques described herein. Training of target content detection models 122-A may be performed using training data that includes content (e.g., depicted or otherwise represented in images, videos, audios, and/or other pertinent data) that may be annotated with ground truth, which may include correct identifications of target and/or non-target content. Training of open vocabulary detection model(s) 122-B may also include zero-shot training with the model(s) given training prompts to identify content (e.g., depictions of objects) that have not been encountered in previous training epochs.

During training, the predictions of suitable models 165 may be compared with ground truth annotations. More specifically, training engine 162 may cause a model to process training inputs 164, which may include media items and training prompts, and generate training outputs 166, which represent identifications of content in the corresponding training inputs 164. During training, training engine 162 may also generate mapping data 167 (e.g., metadata) that associates training inputs 164 with correct target outputs 168. Target outputs 168 may include ground truth content identifications for corresponding training inputs 164. Training causes the model(s) 165 to identify patterns in training inputs 164 based on desired target outputs 168 and learn to accurately classify input data.

Initially, edge parameters (e.g., weights and biases) of the model(s) being trained may be assigned some starting (e.g., random) values. For every training input 164, training engine 162 may compare training output 166 with the target output 168. The resulting error or mismatch, e.g., the difference between the desired target output 168 and the generated training output 166 of model(s), may be back-propagated through the model(s) and at least some parameters of model(s) may be changed in a way that brings training output 166 closer to target output 168. Such adjustments may be repeated until the output error for a given training input 164 satisfies a predetermined condition (e.g., falls below a predetermined error). Subsequently, a different training input 164 may be selected, a new training output 166 generated, and a new series of adjustments implemented, until the model is trained to a target degree of precision or until the model converges to a limit of its (architecture-determined) accuracy.

Training server 160 may train any number of content detection models in this (or a similar) fashion using different sets of training inputs 164 and target outputs 168. The trained content detection models may be deployed on any suitable machine, e.g., MCR server 110. Trained content detection models may be stored in model repository 150 and downloaded to MCR server 110. After downloading by MCR server 110, the models may be deployed for inference, e.g., automated recognition of content in media items 108, as disclosed in more detail below.

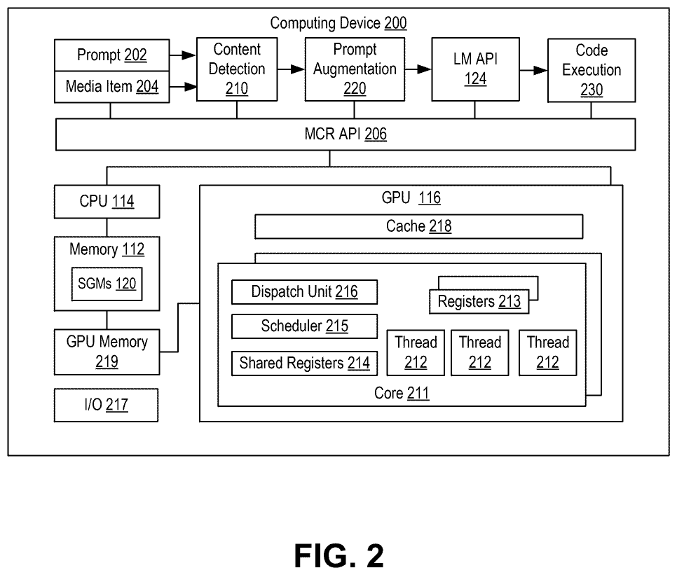

FIG. 2 illustrates an example computing device 200 that supports deployment of systems facilitating automated content recognition with custom computing code generation using language models, according to at least one embodiment. In at least one embodiment, computing device 200 may be a part of MCR server 110 and/or a part of user device 102 (with reference to FIG. 1). In at least one embodiment, computing device 200 may deploy MCR API 206 (which may be a server counterpart of MCR API 106 operating on user device 102, as depicted in FIG. 1) that supports operations of an automated content recognition pipeline. As illustrated in FIG. 2, the automated content recognition pipeline may include receiving a prompt 202 and a media item 204 associated with prompt 202, processing prompt 202 and media item 204 using a content detection stage 210 to obtain a description (which may be responsive to the scope of the prompt) of media item 204, and use the obtained description to perform prompt augmentation 220. The prompt 202 augmented with an explanation of a format of the description of media item 204 may be provided, via LM API 124, to an LM (e.g., LM 132 of FIG. 1) trained to generate computing codes. Code execution 230 may then execute the code produced by the LM to generate a description of the media item 204.

Operations of MCR API 206, content detection stage 210, prompt augmentation 220, LM API 124, code execution 230, and various modules operating in conjunction with the automated content recognition pipeline, and/or other software/firmware instantiated on computing device 200 may be executed using one or more CPUs 114, one or more GPUs 116, one or more parallel processing units (PPUs) or accelerators, such as a deep learning accelerator, data processing units (DPUs), and/or the like. In at least one embodiment, a GPU 116 includes multiple cores 211. An individual core 211 may be capable of executing multiple threads 212. Individual cores 211 may run multiple threads 212 concurrently (e.g., in parallel). In at least one embodiment, threads 212 may have access to registers 213. Registers 213 may be thread-specific registers with access to a register restricted to a respective thread. Additionally, shared registers 214 may be accessed by one or more (e.g., all) threads of a core 211. In at least one embodiment, individual cores 211 may include a scheduler 215 to distribute computational tasks and processes among different threads 212 of the core. A dispatch unit 216 may implement scheduled tasks on appropriate threads using correct private registers 213 and shared registers 214. Computing device 200 may include input/output component(s) 217 to facilitate exchange of information with one or more users or developers.

In at least one embodiment, GPU 116 may have a (high-speed) cache 218, access to which may be shared by multiple cores 211. Furthermore, computing device 200 may include a GPU memory 219 where GPU 116 may store intermediate and/or final results (outputs) of various computations performed by GPU 116. After completion of a particular task, GPU 116 (or CPU 114) may move the output to (main) memory 112. In at least one embodiment, CPU 114 may execute processes that involve serial computational tasks whereas GPU 116 may execute tasks (such as multiplication of inputs of a neural node by weights and adding biases) that are amenable to parallel processing.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine, an in-vehicle infotainment system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems for performing medical operations, systems for performing factory operations, systems for performing analytics operations, systems implemented using an edge device, systems for generating or presenting at least one of augmented reality content, virtual reality content, mixed reality content, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems implementing one or more language models, such as large language models (LLMs) or visual language models (VLMs) that may process text, voice, image, and/or other data types to generate outputs in one or more formats, systems implemented at least partially using cloud computing resources, systems for performing generative AI operations, and/or other types of systems.

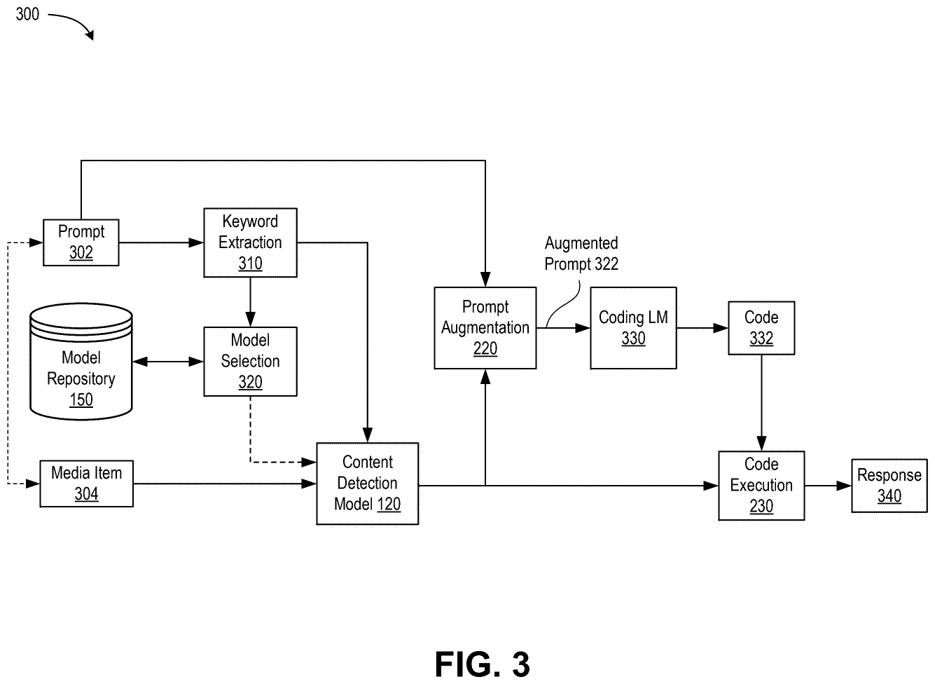

FIG. 3 illustrates an example data flow 300 of automated content recognition with generation of custom computing codes using language models, according to at least one embodiment. Operations illustrated in FIG. 3 may be performed by MCR server 110 (with reference to FIG. 1). In some embodiments, the operations include receiving a prompt 302. Prompt 302 may be received from a user, e.g., as part of a live conversation, or may be generated (and stored) previously and subsequently retrieved from a memory device (e.g., memory 112 of MCR server 110 or memory of user device 102). Prompt 302 may be associated with a media item 304 that may include image(s), video(s) (e.g., temporally, visually, and contextually related sequences of images/frames), audio(s), and or any other data items produced by suitable sensor(s), which may include camera(s), video camera(s), infrared camera(s), microphone(s), sonar(s), lidar(s), radar(s), and/or any other physical or chemical sensors, e.g., temperature sensors, pressure sensors, humidity sensors, smoke-detection sensors, chemical composition sensors, motion-detection sensors, accelerometers, altitude sensors, global positioning sensors, and/or the like. Media item 304 may be (or include) any time series of data, e.g., a sequence of video frames. Media item 304 may be associated with prompt 302. For example, media item 304 may be explicitly referenced in prompt 302 (e.g., by specifying a storage location of media item 304), directly attached (e.g., as a data file) to prompt 302, implicitly associated with prompt 302, and/or associated in any other way that unambiguously identifies media item 304.

Prompt 302 may be a natural language prompt, e.g., for any applicable description of media item 304, which may be (or include) a quantitative description (e.g., a request for number of objects or specific type in media item 304), a qualitative or conceptual description of a content of media item 304 (e.g., whether the red team has scored or missed the goal). Prompt 302 may be formulated as (or include) a question (e.g., “how many players in the white-and-blue uniform were on ice right before the play stoppage?”), an instruction (e.g., “count the number of players in the white-and-blue uniform on ice prior to the play stoppage”), a task (e.g., determine if the white-and-blue team had too many players on ice before the play stoppage”), and/or an inquiry in any other suitable form. In some embodiments, the prompt 302 may be a textual representation of an audio data or visual data from a user or retrieved from memory.

In some embodiments, prompt 302 may undergo keyword extraction 310 that identifies a type of a target content in media item 304. In some embodiments, keyword extraction 310 may use an LM, e.g., a foundational model trained to understand human language (but not necessarily trained in some specialized tasks). In some embodiments, an LM used in keyword extraction 310 may be the same as a model used to generate a computing code (e.g., coding LM 330). In some embodiments, an LM used for keyword extraction 310 may be different from a model used to generate the computing code. In some embodiments, keyword extraction 310 may use any combination of morphological, syntactic, statistical, graph-based approaches, and/or any combination thereof to extract keywords from prompt 302. In some embodiments, keyword extraction 310 may use a trained machine learning classifier, e.g., a discriminative classifier, a decoder-only classifier, and/or the like.

Keyword extraction 310 may generate a list of keywords (also referred to as grounded noun groups and/or the like) for prompt 302. For example, the list of keywords may include “player,” “white-and-blue uniform,” “on the ice,” and/or the like. In some instances, the list of keywords may include one or more words that are not part of prompt 302 but are semantically close to one or more words of prompt 302. For example, the list of keywords of a prompt to determine how many puppies a dog sitter in an image is walking may include the word “dog” even though this word is not explicitly included in the original prompt. In some implementations, keyword extraction 310 may generate some representation of prompt 302 that is different from a list of keywords. For example, a representation of prompt 302 may be (or include) a list of word embeddings or tokens that can be understood by a machine learning model, generated by a suitable tokenizer (not shown explicitly in FIG. 3).

The representation of prompt 302 may be used by a model selection stage 320 that selects one or more content detection models 120 for processing of media item 304. In some embodiments, the representation of prompt 302 may be (or include) prompt 302 itself. In some embodiments, the representation of prompt 302 may include the list of keywords of prompt 302. In some embodiments, the representation of prompt 302 may include a set of tokens for prompt 302 or a set of tokens for the keywords.

Tokens may encode units of speech (e.g., words, syllables, etc.) as numbers. In one example of GPT-4 tokens, word “the” may be represented via token “280”, word “import” may be represented via token “476,” word “description” may be represented via token “4097,” and so on. In some embodiments, individual words may be represented via any number of tokens or word transitions. For example, a long word or a word that contains multiple words may be represented via multiple tokens, e.g., with one token used to represent a beginning portion of the word and another token(s) representing a middle or end portion of the word. In some instances, even a long/composite word may be represented by a single token. As such, the tokenization may be performed in any manner that is suitable for inputting into a language-based content detection model.

The content detection model(s) 120 may be selected from model repository 150, which may include target content detection models 122-A trained to detect specific target content of interest, open vocabulary content detection models 122-B trained to identify unfamiliar content, and/or other suitable models. In some embodiments, model selection stage 320 may compare the list of keywords to a list of reference words associated with various target content detection models 122-A and compute similarity scores (e.g., cosine similarity values) between the keywords and the reference words. If at least some of the similarity scores are above a certain empirically set threshold, model selection stage 320 may select the corresponding target content detection model(s) 122-A. If the similarity scores are below the threshold, model selection stage 320 may select one of available open vocabulary content detection models 122-B.

The selected content detection model(s) 120 may process the representation of prompt 302 and media item 304 and output a suitable characterization of media item 304. The characterization may include any pertinent information contained in media item 304 about entities identified in prompt 302, e.g., by keywords for prompt 302. In one example embodiment, e.g., where media item 304 includes an image or a video, the characterization of media item 304 may include bounding boxes, object types/classes, and/or other identifying information for objects in media item 304. In another non-limiting example, the output of content detection model(s) 120 may include segmentation map(s) for media items 304, e.g., classifications of individual pixels (or groups of pixels) among two or more classes, e.g., “target object pixel,” “background pixel,” and/or the like.

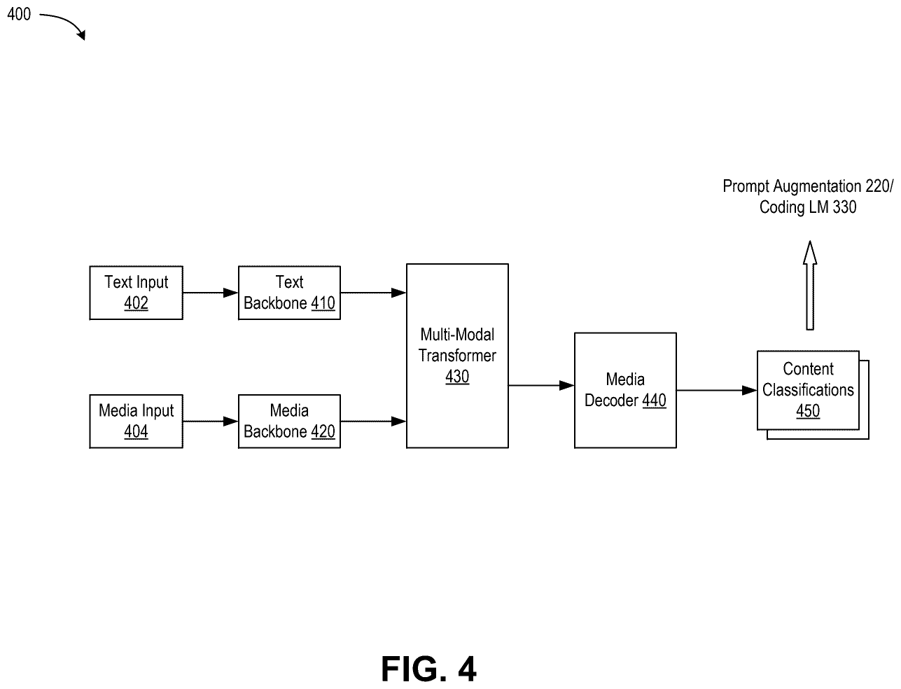

FIG. 4 illustrates an example architecture of an open vocabulary content detection model 400 that can be used for automated content recognition with custom computing code generation, according to at least one embodiment. In some embodiments, open vocabulary content detection model 400 may be one of open vocabulary content detection models 122-B of FIG. 1 and may be deployed as one of content detection models 120 on MCR server 110. Open vocabulary content detection model 400 may include a language-comprehension portion, e.g., text backbone 410 that processes text inputs 402 (such as prompts 302, with reference to FIG. 3), and a media-processing portion, e.g., media backbone 420 that processes media inputs 404 (such as media items 304). In one example, the media backbone 420 may be trained to identify visual patterns in images of various objects and the text backbone 410 may be trained to identify contextual and semantic connections between various units (e.g., words, phrases, etc.) of texts. Text backbone 410 and/or media backbone 420 may include one or more self-attention blocks to identify associations between different units of the respective inputs. Outputs of processing by text backbone 410 and media backbone 420 may be processed by a multi-modal transformer that uses one or more cross-attention blocks (but may also include any number of self-attention blocks) to identify associations between units of text input 402 and units of content of media input 404. Intermediate outputs of multi-modal transformer 430 may be processed by a suitable classifier, e.g., a media decoder 440 that generates content classifications 450, including any suitable characterizations of media input 404, such as pixel-level classifications, object-level detections (e.g., bounding boxes, convex hulls, etc.) and classifications, audio feature detections, detections of features that occur in sensor data, and/or the like. Content classifications 450 may be used for prompt augmentation 220 and code generation, e.g., as disclosed in more detail below.

Referring again to FIG. 3, in one example non-limiting embodiment, the characterization of media item 304 obtained by content detection model may have the following illustrative format:
“filename”: “basketball court.jpg”
“height”: 693
“width”: 1024
“caption”: “basketball player on court”
“detection”:
   “instances”:
      “id”: 1
         “bbox”: [262, 210, 323, 338],
         “confidence”: 0.93,
         “class_name”: “basketball_player”
      “id”: 2
         “bbox”: [354, 330, 426, 514],
         “confidence”: 0.91,
         “class_name”: “basketball_player”
      “id”: 3
         “bbox”: [126, 202, 276, 282],
         “confidence”: 0.94,
         “class_name”: “basketball_player”
            which specifies the filename of media item 304 (“basketball court.jpg”), dimensions of media item (693×1024 pixels), a list of keywords/captions (“basketball player on court”) for which the content detection has been performed, and various detections identified with bounding boxes (“bbox”) for the detected objects, classes (“basketball_player”) of detected objects, and confidences in the detections.

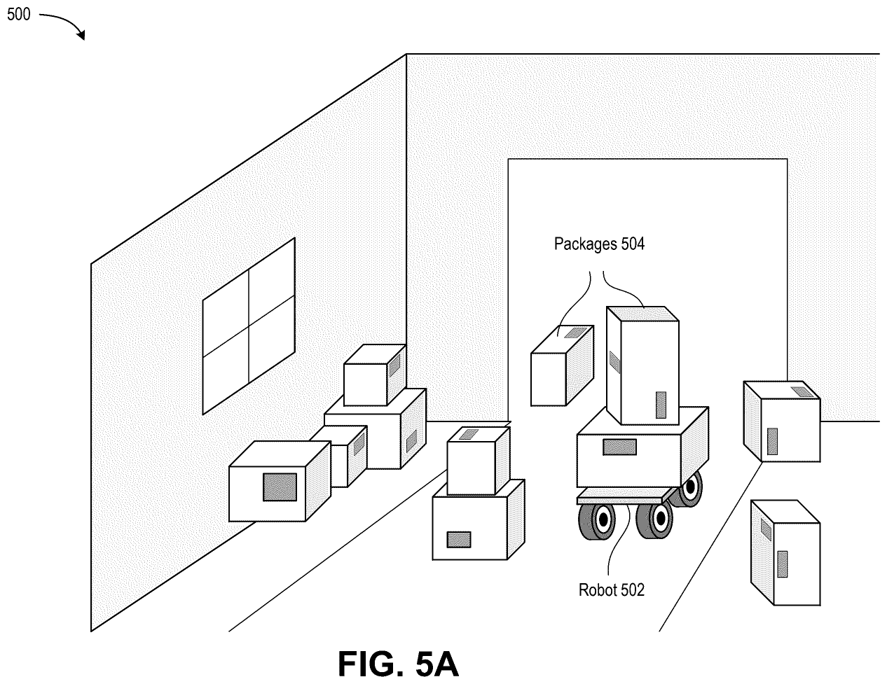

FIGS. 5A-5B illustrate schematically content detection that can be used with custom computing code generation, according to at least one embodiment. FIG. 5A depicts an image 500 of a shipping warehouse that includes a robot 502 and multiple packages 504. Image 500 may be used as a media item 304 in conjunction with a suitable prompt 302, e.g., “how many packages are being transported by the robot?” FIG. 5B depicts an image 510 of the shipping warehouse annotated with detections performed by a content detection model. As illustrated, the annotations—shown as bounding boxes—include a robot detection 512 and package detections 514.

Referring again to FIG. 3, the characterizations of content of media item 304 obtained by one or more content detection models 120 may be used for prompt augmentation 220. Prompt augmentation 220 may be used to augment prompt 302 with the media item characterizations. The augmented prompt 322 may further include an instruction asking a coding LM 330 to write a code that performs a computational task described in prompt 302 in association with media item 304, given the information included in the characterization of media item 304 (generated by content detection model(s) 120). In one non-limiting example, augmented prompt 322 may be: “write a Python code to identify how many basketball players are on the court in the image given the provided characterization of the image.” Augmented prompt 322 may further include an explanation of a format of the characterization, e.g., descriptions of various fields (“bounding boxes,” “objects,” “confidences,” and/or the like) in the characterization. In some embodiments, the explanation may be provided in a natural language form.

Coding LM 330 may process the augmented prompt 322 and generate a code 332, e.g., source code or object code, capable of extracting information contained in the characterization of the media item 304 responsive to prompt 302. Code 332, produced by LM 330, may include a list of commands (operators) with instructions to a processing device regarding how to (i) extract and analyze data contained in the characterization of the media item 304 and (ii) generate a response to prompt 302.

The code 332 written (generated) by coding LM 330 may be processed by code execution 230. Code execution 230 may include a compiler (if needed) to translate the source code into a machine code and a processing logic to execute the machine code. An output of code execution 230 may be a response 340, e.g., a natural language phrase that may be understood by a human user, e.g., creator of prompt 302. In some embodiments, response 340 may be preformatted by the coding LM 330 with fillable blanks, e.g., “[ . . . ] basketball players are on the court,” with the blanks filled out with numerical or other suitable values upon execution of the code 332.

In some embodiments, code 332 generated by coding LM 330 may not always compile and/or execute successfully during code execution 230. In instances of error, code 332 may be returned to coding LM 330 together with a log of compilation and/or execution errors and coding LM 330 may perform debugging of code 332. Such debugging may be performed iteratively, using multiple attempts. In some instances, coding LM 330 may write a new code 332 in a different language. For example, if a C++ code does not work after a set number of iterations, coding LM 330 may be requested (e.g., by prompt augmentation 220 generating a new augmented prompt 322) to write a Python code or JavaScript code or a code in some other language. In some embodiments, after a predetermined maximum number of attempts has not resulted in workable code (e.g., a code that can be successfully compiled and/or executed), coding LM 330 may output a final error and a human developer may manually correct and/or debug code 332. The corrected code 332 may then be used for instructional on-the-fly training of LM 330 so that coding LM 330 does not make the same error(s) in the future.

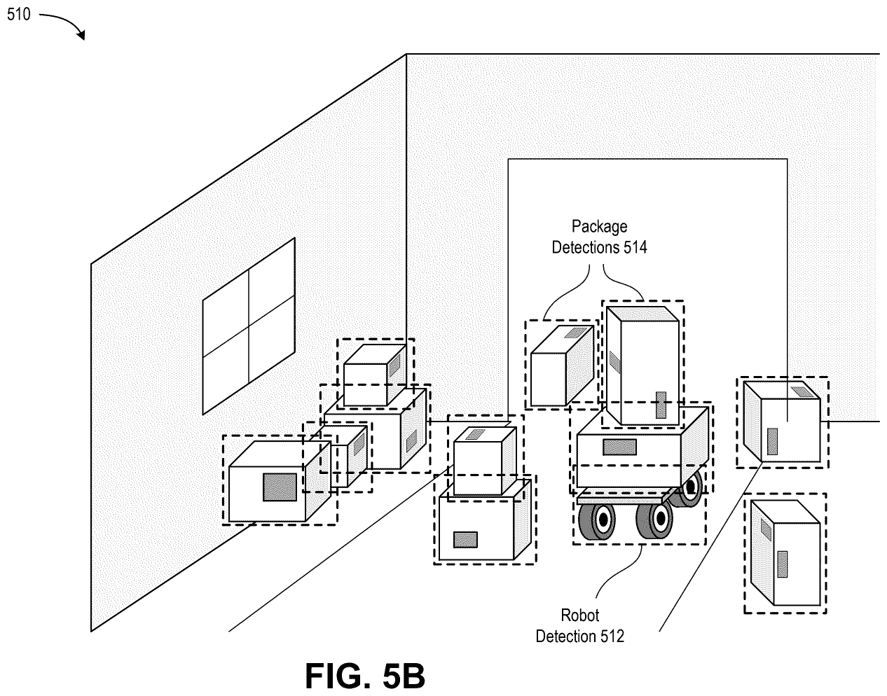

FIG. 6 is a flow diagram of an example method 600 of automated content recognition with custom computing code generation using language models, according to at least one embodiment. In at least one embodiment, method 600 may be performed using processing units of computing device 200 of FIG. 2, which may be (or include) a device associated with MCR server 110, LM service 130, user device 102, and/or other devices. In at least one embodiment, processing units performing method 600 may be executing instructions stored on a non-transient computer-readable storage media. In at least one embodiment, method 600 may be performed using multiple processing threads (e.g., CPU threads and/or GPU threads), with individual threads executing one or more individual functions, routines, subroutines, or operations of the methods. In at least one embodiment, processing threads implementing method 600 may be synchronized (e.g., using semaphores, critical sections, and/or other thread synchronization mechanisms). Alternatively, processing threads implementing method 600 may be executed asynchronously with respect to each other. Various operations of method 600 may be performed in a different order compared with the order shown in FIG. 6. Some operations of method 600 may be performed concurrently with other operations. In at least one embodiment, one or more operations shown in FIG. 6 may not always be performed.

At block 610, method 600 may include obtaining a first prompt for a responsive, to the first prompt, description of a media item. In some embodiments, the media item may be or include an image item, a video item, an audio item, sensor data item, and/or the like. For example, a user may enter any suitable query (e.g., prompt 302 of FIG. 3) about an image, video, a set of data (e.g., media item 304), and/or the like. In some embodiments, the first prompt may be or include a natural language prompt. In some embodiments, the first prompt may be a textual representation of an audio data or visual data from a user or retrieved from memory.

At block 620, method 600 may include processing, using at least one content detection model, the media item and a representation of the first prompt to obtain a characterization of the media item. In some embodiments, the representation of the first prompt may include one or more keywords associated with the first prompt. In some embodiments, the at least one content detection model may be selected, using the representation of the first prompt, from a plurality of trained models. In some embodiments, the at least one content detection model may include an object detection model trained to detect one or more objects associated with the representation of the first prompt. In some embodiments, the at least one content detection model may include an open vocabulary model (e.g., an open vocabulary content detection model 400 of FIG. 4) that includes a computer vision portion (e.g., media backbone 420) to process at least the media item, a language-comprehension portion (e.g., text backbone 410) to process at least the characterization of the media item, and a classifier portion (e.g., multi-modal transformer 430 and/or media decoder 440) to process outputs of the computer vision portion and the language-comprehension portion to obtain the characterization of the media item. In some embodiments, the characterization of the media item may include one or more bounding boxes for respective one or more objects in the media item (e.g., as illustrated in FIG. 5B). In some embodiments, the characterization of the media item from all content detection models processing the media item may be aggregated (combined) prior to downstream use.

At block 630, method 600 may continue with generating, using the first prompt and the characterization of the media item, a second prompt (e.g., augmented prompt 322 in FIG. 3) that includes an instruction to a language model (LM). In some embodiments, the instruction for the LM may include a natural language explanation of a format of the characterization of the media item. The LM may be trained to generate a computing code to perform a computing task responsive to a natural language instruction that includes a description of the computing task.

At block 640, method 600 may continue with causing the LM to process the second prompt to generate a computing code (e.g., code 332) associated with the characterization of the media item. At block 650, method 600 may include causing the computing code to be executed to generate the responsive description of the media item (e.g., response 340).

The systems and methods described herein may be used for a variety of purposes, by way of example and without limitation, for performing one or more operations with respect to machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., an in-vehicle infotainment system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems for performing medical operations, systems for performing factory operations, systems for performing analytics operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

### Inference and Training Logic

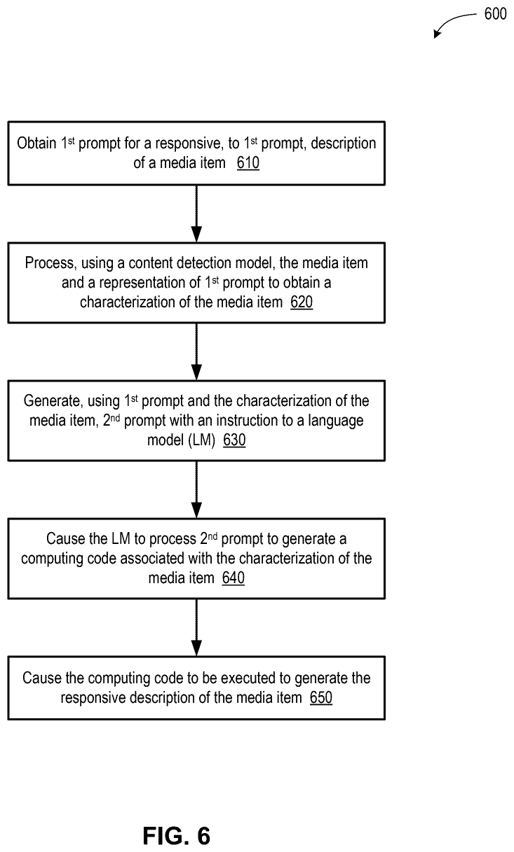

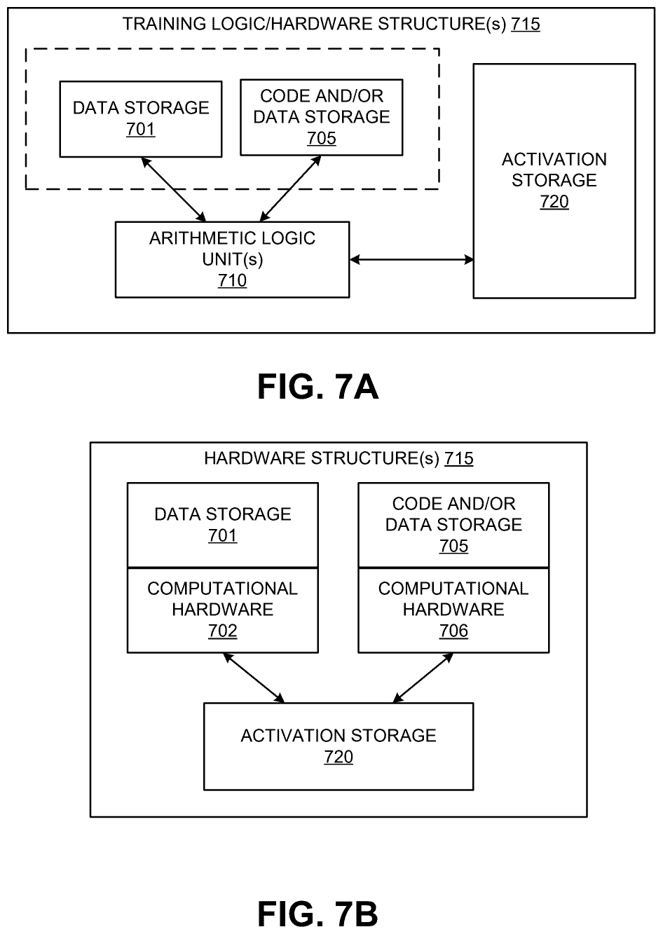

FIG. 7A illustrates inference and/or training logic 715 used to perform inferencing and/or training operations associated with one or more embodiments.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating-point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or code and/or data storage 701 may be cache memory, dynamic randomly addressable memory (“DRAM”), static randomly addressable memory (“SRAM”), non-volatile memory (e.g., flash memory), or other storage. In at least one embodiment, a choice of whether code and/or code and/or data storage 701 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs).

In at least one embodiment, code, such as graph code, causes the loading of weight or other parameter information into processor ALUs based on an architecture of a neural network to which such code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to one or more processors or other hardware logic devices or circuits. In at least one embodiment, code and/or data storage 705 may be cache memory, DRAM, SRAM, non-volatile memory (e.g., flash memory), or other storage. In at least one embodiment, a choice of whether code and/or data storage 705 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be a combined storage structure. In at least one embodiment, code and/or data storage 701 and code and/or data storage 705 may be partially combined and partially separate. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710,including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., flash memory), or other storage. In at least one embodiment, activation storage 720 may be completely or partially within or external to one or more processors or other logical circuits. In at least one embodiment, a choice of whether activation storage 720 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 illustrated in FIG. 7A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one embodiment. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one storage/computational pair 701/702 of code and/or data storage 701 and computational hardware 702 is provided as an input to a next storage/computational pair 705/706 of code and/or data storage 705 and computational hardware 706, in order to mirror a conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage/computation pairs 701/702 and 705/706 may be included in inference and/or training logic 715.

### Neural Network Training and Deployment

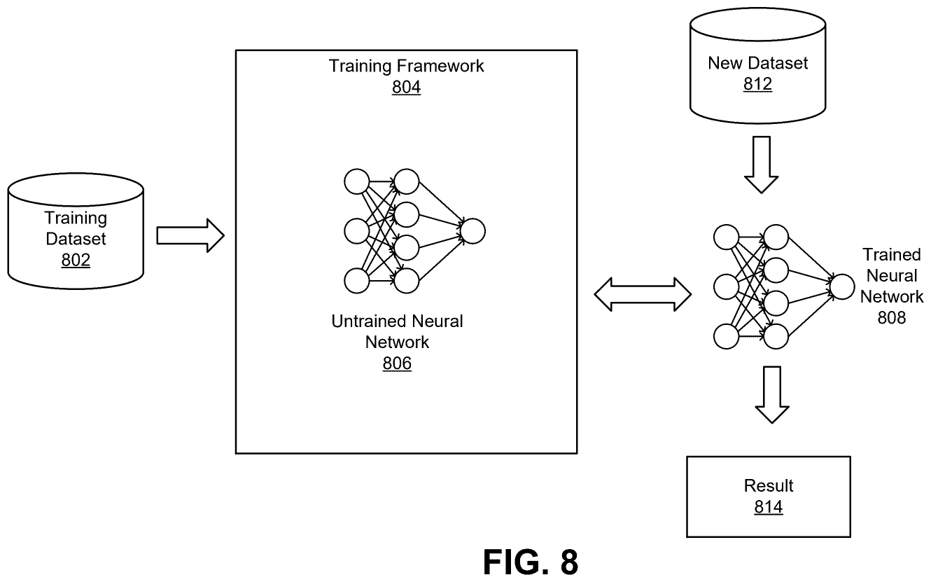

FIG. 8 illustrates training and deployment of a deep neural network, according to at least one embodiment. In at least one embodiment, untrained neural network 806 is trained using a training dataset 802. In at least one embodiment, training framework 804 is a PyTorch framework, whereas in other embodiments, training framework 804 is a TensorFlow, Boost, Caffe, Microsoft Cognitive Toolkit/CNTK, MXNet, Chainer, Keras, Deeplearning4j, or other training framework. In at least one embodiment, training framework 804 trains an untrained neural network 806 and enables it to be trained using processing resources described herein to generate a trained neural network 808. In at least one embodiment, weights may be chosen randomly or by pre-training using a deep belief network. In at least one embodiment, training may be performed in either a supervised, partially supervised, or unsupervised manner.

In at least one embodiment, untrained neural network 806 is trained using supervised learning, wherein training dataset 802 includes an input paired with a desired output for an input, or where training dataset 802 includes input having a known output and an output of neural network 806 is manually graded. In at least one embodiment, untrained neural network 806 is trained in a supervised manner and processes inputs from training dataset 802 and compares resulting outputs against a set of expected or desired outputs. In at least one embodiment, errors are then propagated back through untrained neural network 806. In at least one embodiment, training framework 804 adjusts weights that control untrained neural network 806. In at least one embodiment, training framework 804 includes tools to monitor how well untrained neural network 806 is converging towards a model, such as trained neural network 808, suitable to generating correct answers, such as in result 814, based on input data such as a new dataset 812. In at least one embodiment, training framework 804 trains untrained neural network 806 repeatedly while adjusting weights to refine an output of untrained neural network 806 using a loss function and adjustment algorithm, such as stochastic gradient descent. In at least one embodiment, training framework 804 trains untrained neural network 806 until untrained neural network 806 achieves a desired accuracy. In at least one embodiment, trained neural network 808 can then be deployed to implement any number of machine learning operations.

In at least one embodiment, untrained neural network 806 is trained using unsupervised learning, whereas untrained neural network 806 attempts to train itself using unlabeled data. In at least one embodiment, unsupervised learning training dataset 802 will include input data without any associated output data or “ground truth” data. In at least one embodiment, untrained neural network 806 can learn groupings within training dataset 802 and can determine how individual inputs are related to untrained dataset 802. In at least one embodiment, unsupervised training can be used to generate a self-organizing map in trained neural network 808 capable of performing operations useful in reducing dimensionality of new dataset 812. In at least one embodiment, unsupervised training can also be used to perform anomaly detection, which allows identification of data points in new dataset 812 that deviate from normal patterns of new dataset 812.

In at least one embodiment, semi-supervised learning may be used, which is a technique in which in training dataset 802 includes a mix of labeled and unlabeled data. In at least one embodiment, training framework 804 may be used to perform incremental learning, such as through transferred learning techniques. In at least one embodiment, incremental learning enables trained neural network 808 to adapt to new dataset 812 without forgetting knowledge instilled within trained neural network 808 during initial training.

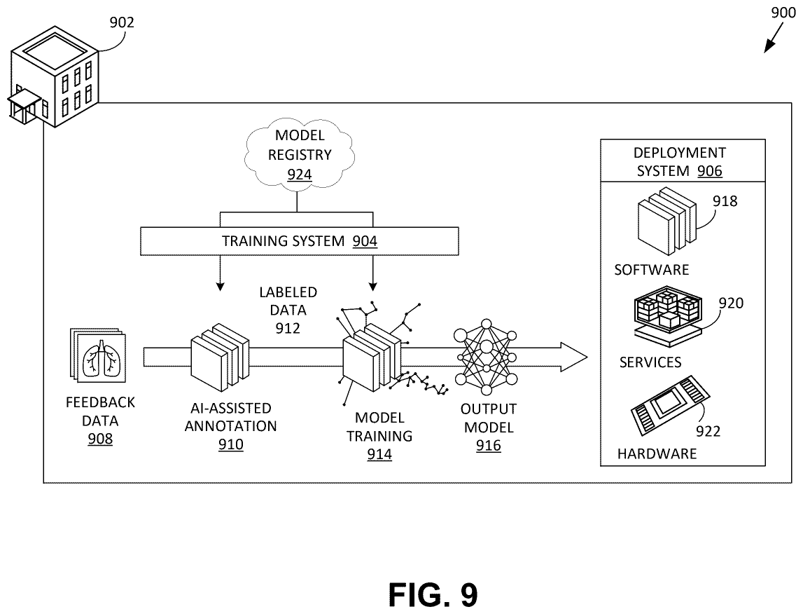

With reference to FIG. 9, FIG. 9 is an example data flow diagram for a process 900 of generating and deploying a processing and inferencing pipeline, according to at least one embodiment. In at least one embodiment, process 900 may be deployed to perform game name recognition analysis and inferencing on user feedback data at one or more facilities 902, such as a data center.

In at least one embodiment, process 900 may be executed within a training system 904 and/or a deployment system 906. In at least one embodiment, training system 904 may be used to perform training, deployment, and embodiment of machine learning models (e.g., neural networks, object detection algorithms, computer vision algorithms, etc.) for use in deployment system 906. In at least one embodiment, deployment system 906 may be configured to offload processing and compute resources among a distributed computing environment to reduce infrastructure requirements at facility 902. In at least one embodiment, deployment system 906 may provide a streamlined platform for selecting, customizing, and implementing virtual instruments for use with computing devices at facility 902. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 906 during execution of applications.

In at least one embodiment, some applications used in advanced processing and inferencing pipelines may use machine learning models or other AI to perform one or more processing steps. In at least one embodiment, machine learning models may be trained at facility 902 using feedback data 908 (such as imaging data) stored at facility 902 or feedback data 908 from another facility or facilities, or a combination thereof. In at least one embodiment, training system 904 may be used to provide applications, services, and/or other resources for generating working, deployable machine learning models for deployment system 906.

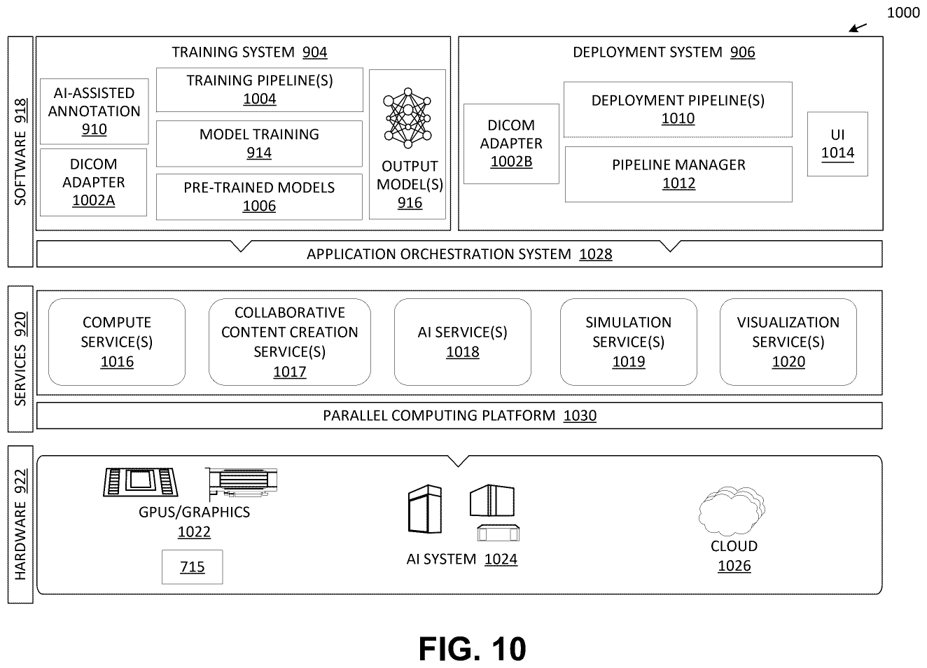

In at least one embodiment, a model registry 924 may be backed by object storage that may support versioning and object metadata. In at least one embodiment, object storage may be accessible through, for example, a cloud storage (e.g., a cloud 1026 of FIG. 10) compatible application programming interface (API) from within a cloud platform. In at least one embodiment, machine learning models within model registry 924 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline 1004 (FIG. 10) may include a scenario where facility 902 is training their own machine learning model, or has an existing machine learning model that needs to be optimized or updated. In at least one embodiment, feedback data 908 may be received from various channels, such as forums, web forms, or the like. In at least one embodiment, once feedback data 908 is received, AI-assisted annotation 910 may be used to aid in generating annotations corresponding to feedback data 908 to be used as ground truth data for a machine learning model. In at least one embodiment, AI-assisted annotation 910 may include one or more machine learning models (e.g., convolutional neural networks (CNNs)) that may be trained to generate annotations corresponding to certain types of feedback data 908 (e.g., from certain devices) and/or certain types of anomalies in feedback data 908. In at least one embodiment, AI-assisted annotations 910 may then be used directly, or may be adjusted or fine-tuned using an annotation tool, to generate ground truth data. In at least one embodiment, in some examples, labeled data 912 may be used as ground truth data for training a machine learning model. In at least one embodiment, AI-assisted annotations 910, labeled data 912, or a combination thereof may be used as ground truth data for training a machine learning model, e.g., via model training 914 in FIGS. 9-10. In at least one embodiment, a trained machine learning model may be referred to as an output model 916, and may be used by deployment system 906, as described herein.

In at least one embodiment, training pipeline 1004 (FIG. 10) may include a scenario where facility 902 needs a machine learning model for use in performing one or more processing tasks for one or more applications in deployment system 906, but facility 902 may not currently have such a machine learning model (or may not have a model that is optimized, efficient, or effective for such purposes). In at least one embodiment, an existing machine learning model may be selected from model registry 924. In at least one embodiment, model registry 924 may include machine learning models trained to perform a variety of different inference tasks on imaging data. In at least one embodiment, machine learning models in model registry 924 may have been trained on imaging data from different facilities than facility 902 (e.g., facilities that are remotely located). In at least one embodiment, machine learning models may have been trained on imaging data from one location, two locations, or any number of locations. In at least one embodiment, when being trained on imaging data, which may be a form of feedback data 908, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 924. In at least one embodiment, a machine learning model may then be retrained, or updated, at any number of other facilities, and a retrained or updated model may be made available in model registry 924. In at least one embodiment, a machine learning model may then be selected from model registry 924—and referred to as output model 916—and may be used in deployment system 906 to perform one or more processing tasks for one or more applications of a deployment system.

In at least one embodiment, training pipeline 1004 (FIG. 10) may be used in a scenario that includes facility 902 requiring a machine learning model for use in performing one or more processing tasks for one or more applications in deployment system 906, but facility 902 may not currently have such a machine learning model (or may not have a model that is optimized, efficient, or effective for such purposes). In at least one embodiment, a machine learning model selected from model registry 924 might not be fine-tuned or optimized for feedback data 908 generated at facility 902 because of differences in populations, genetic variations, robustness of training data used to train a machine learning model, diversity in anomalies of training data, and/or other issues with training data. In at least one embodiment, AI-assisted annotation 910 may be used to aid in generating annotations corresponding to feedback data 908 to be used as ground truth data for retraining or updating a machine learning model. In at least one embodiment, labeled data 912 may be used as ground truth data for training a machine learning model. In at least one embodiment, retraining or updating a machine learning model may be referred to as model training 914. In at least one embodiment, model training 914—e.g., AI-assisted annotations 910, labeled data 912, or a combination thereof—may be used as ground truth data for retraining or updating a machine learning model.

In at least one embodiment, deployment system 906 may include software 918, services 920, hardware 922, and/or other components, features, and functionality. In at least one embodiment, deployment system 906 may include a software “stack,” such that software 918 may be built on top of services 920 and may use services 920 to perform some or all of processing tasks, and services 920 and software 918 may be built on top of hardware 922 and use hardware 922 to execute processing, storage, and/or other compute tasks of deployment system 906.

In at least one embodiment, software 918 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 908 (or other data types, such as those described herein). In at least one embodiment, an advanced processing and inferencing pipeline may be defined based on selections of different containers that are desired or required for processing feedback data 908, in addition to containers that receive and configure imaging data for use by each container and/or for use by facility 902 after processing through a pipeline (e.g., to convert outputs back to a usable data type for storage and display at facility 902). In at least one embodiment, a combination of containers within software 918 (e.g., that make up a pipeline) may be referred to as a virtual instrument (as described in more detail herein), and a virtual instrument may leverage services 920 and hardware 922 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 916 of training system 904.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 924 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 920 as a system (e.g., architecture 1000 of FIG. 10). In at least one embodiment, once validated by architecture 1000 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., architecture 1000 of FIG. 10). In at least one embodiment, completed and validated applications or containers may be stored in a container registry and associated machine learning models may be stored in model registry 924. In at least one embodiment, a requesting entity that provides an inference or image processing request may browse a container registry and/or model registry 924 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 906 (e.g., a cloud) to perform processing of a data processing pipeline. In at least one embodiment, processing by deployment system 906 may include referencing selected elements (e.g., applications, containers, models, etc.) from a container registry and/or model registry 924. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 920 may be leveraged. In at least one embodiment, services 920 may include compute services, collaborative content creation services, simulation services, artificial intelligence (AI) services, visualization services, and/or other service types. In at least one embodiment, services 920 may provide functionality that is common to one or more applications in software 918, so functionality may be abstracted to a service that may be called upon or leveraged by applications. In at least one embodiment, functionality provided by services 920 may run dynamically and more efficiently, while also scaling well by allowing applications to process data in parallel, e.g., using a parallel computing platform 1030 (FIG. 10). In at least one embodiment, rather than each application that shares a same functionality offered by a service 920 being required to have a respective instance of service 920, service 920 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 920 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 918 implementing advanced processing and inferencing pipeline may be streamlined because each application may call upon the same inference service to perform one or more inferencing tasks.

In at least one embodiment, hardware 922 may include GPUs, CPUs, graphics cards, an AI/deep learning system (e.g., an AI supercomputer, such as NVIDIA's DGX™ supercomputer system), a cloud platform, or a combination thereof. In at least one embodiment, different types of hardware 922 may be used to provide efficient, purpose-built support for software 918 and services 920 in deployment system 906. In at least one embodiment, use of GPU processing may be implemented for processing locally (e.g., at facility 902), within an AI/deep learning system, in a cloud system, and/or in other processing components of deployment system 906 to improve efficiency, accuracy, and efficacy of game name recognition.

In at least one embodiment, software 918 and/or services 920 may be optimized for GPU processing with respect to deep learning, machine learning, and/or high-performance computing, simulation, and visual computing, as non-limiting examples. In at least one embodiment, at least some of the computing environment of deployment system 906 and/or training system 904 may be executed in a datacenter or one or more supercomputers or high performance computing systems, with GPU-optimized software (e.g., hardware and software combination of NVIDIA's DGX™ system). In at least one embodiment, hardware 922 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 10 is a system diagram for an example architecture 1000 for generating and deploying a deployment pipeline, according to at least one embodiment. In at least one embodiment, architecture 1000 may be used to implement process 900 of FIG. 9 and/or other processes including advanced processing and inferencing pipelines. In at least one embodiment, architecture 1000 may include training system 904 and deployment system 906. In at least one embodiment, training system 904 and deployment system 906 may be implemented using software 918, services 920, and/or hardware 922, as described herein.

In at least one embodiment, architecture 1000 (e.g., training system 904 and/or deployment system 906) may implemented in a cloud computing environment (e.g., using cloud 1026). In at least one embodiment, architecture 1000 may be implemented locally with respect to a facility, or as a combination of both cloud and local computing resources. In at least one embodiment, access to APIs in cloud 1026 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of architecture 1000, may be restricted to a set of public internet service providers (ISPs) that have been vetted or authorized for interaction.

In at least one embodiment, various components of architecture 1000 may communicate between and among one another using any of a variety of different network types, including but not limited to local area networks (LANs) and/or wide area networks (WANs) via wired and/or wireless communication protocols. In at least one embodiment, communication between facilities and components of architecture 1000 (e.g., for transmitting inference requests, for receiving results of inference requests, etc.) may be communicated over a data bus or data busses, wireless data protocols (Wi-Fi), wired data protocols (e.g., Ethernet), etc.

In at least one embodiment, training system 904 may execute training pipelines 1004, similar to those described herein with respect to FIG. 9. In at least one embodiment, where one or more machine learning models are to be used in deployment pipelines 1010 by deployment system 906, training pipelines 1004 may be used to train or retrain one or more (e.g., pre-trained) models, and/or implement one or more of pre-trained models 1006 (e.g., without a need for retraining or updating). In at least one embodiment, as a result of training pipelines 1004, output model(s) 916 may be generated. In at least one embodiment, training pipelines 1004 may include any number of processing steps, AI-assisted annotation 910, labeling or annotating of feedback data 908 to generate labeled data 912, model selection from a model registry, model training 914, training, retraining, or updating models, and/or other processing steps. In at least one embodiment, for different machine learning models used by deployment system 906, different training pipelines 1004 may be used. In at least one embodiment, training pipeline 1004, similar to a first example described with respect to FIG. 9, may be used for a first machine learning model, training pipeline 1004, similar to a second example described with respect to FIG. 9, may be used for a second machine learning model, and training pipeline 1004, similar to a third example described with respect to FIG. 9, may be used for a third machine learning model. In at least one embodiment, any combination of tasks within training system 904 may be used depending on what is required for each respective machine learning model. In at least one embodiment, one or more of machine learning models may already be trained and ready for deployment so machine learning models may not undergo any processing by training system 904, and may be implemented by deployment system 906.

In at least one embodiment, output model(s) 916 and/or pre-trained model(s) 1006 may include any types of machine learning models depending on embodiment. In at least one embodiment, and without limitation, machine learning models used by architecture 1000 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipelines 1004 may include AI-assisted annotation. In at least one embodiment, labeled data 912 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 908 (or other data type used by machine learning models), there may be corresponding ground truth data generated by training system 904. In at least one embodiment, AI-assisted annotation may be performed as part of deployment pipelines 1010; either in addition to, or in lieu of, AI-assisted annotation included in training pipelines 1004. In at least one embodiment, architecture 1000 may include a multi-layer platform that may include a software layer (e.g., software 918) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 902. In at least one embodiment, applications may then call or execute one or more services 920 for performing compute, AI, or visualization tasks associated with respective applications, and software 918 and/or services 920 may leverage hardware 922 to perform processing tasks in an effective and efficient manner.

In at least one embodiment, deployment system 906 may execute deployment pipelines 1010. In at least one embodiment, deployment pipelines 1010 may include any number of applications that may be sequentially, non-sequentially, or otherwise applied to feedback data (and/or other data types), including AI-assisted annotation, as described above. In at least one embodiment, as described herein, a deployment pipeline 1010 for an individual device may be referred to as a virtual instrument for a device. In at least one embodiment, for a single device, there may be more than one deployment pipeline 1010 depending on information desired from data generated by a device.

In at least one embodiment, applications available for deployment pipelines 1010 may include any application that may be used for performing processing tasks on feedback data or other data from devices. In at least one embodiment, because various applications may share common image operations, in some embodiments, a data augmentation library (e.g., as one of services 920) may be used to accelerate these operations. In at least one embodiment, to avoid bottlenecks of conventional processing approaches that rely on CPU processing, parallel computing platform 1030 may be used for GPU acceleration of these processing tasks.

In at least one embodiment, deployment system 906 may include a user interface (UI) 1014 (e.g., a graphical user interface, a web interface, etc.) that may be used to select applications for inclusion in deployment pipeline(s) 1010, arrange applications, modify or change applications or parameters or constructs thereof, use and intera with deployment pipeline(s) 1010 during set-up and/or deployment, and/or to otherwise interact with deployment system 906. In at least one embodiment, although not illustrated with respect to training system 904, UI 1014 (or a different user interface) may be used for selecting models for use in deployment system 906, for selecting models for training, or retraining, in training system 904, and/or for otherwise interacting with training system 904. In at least one embodiment, training system 904 and deployment system 906 may include DICOM adapters 1002A and 1002B.

In at least one embodiment, pipeline manager 1012 may be used, in addition to an application orchestration system 1028, to manage interaction between applications or containers of deployment pipeline(s) 1010 and services 920 and/or hardware 922. In at least one embodiment, pipeline manager 1012 may be configured to facilitate interactions from application to application, from application to service 920, and/or from application or service to hardware 922. In at least one embodiment, although illustrated as included in software 918, this is not intended to be limiting, and in some examples pipeline manager 1012 may be included in services 920. In at least one embodiment, application orchestration system 1028 (e.g., Kubernetes, DOCKER, etc.) may include a container orchestration system that may group applications into containers as logical units for coordination, management, scaling, and deployment. In at least one embodiment, by associating applications from deployment pipeline(s) 1010 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1012 and application orchestration system 1028. In at least one embodiment, so long as an expected input and/or output of each container or application is known by a system (e.g., based on constructs of applications or containers), application orchestration system 1028 and/or pipeline manager 1012 may facilitate communication among and between, and sharing of resources among and between, each of applications or containers. In at least one embodiment, because one or more of applications or containers in deployment pipeline(s) 1010 may share the same services and resources, application orchestration system 1028 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1028) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 920 leveraged and shared by applications or containers in deployment system 906 may include compute services 1016, collaborative content creation services 1017, AI services 1018, simulation services 1019, visualization services 1020, and/or other service types. In at least one embodiment, applications may call (e.g., execute) one or more of services 920 to perform processing operations for an application. In at least one embodiment, compute services 1016 may be leveraged by applications to perform super-computing or other high-performance computing (HPC) tasks. In at least one embodiment, compute service(s) 1016 may be leveraged to perform parallel processing (e.g., using a parallel computing platform 1030) for processing data through one or more of applications and/or one or more tasks of a single application, substantially simultaneously. In at least one embodiment, parallel computing platform 1030 (e.g., NVIDIA's CUDA®) may enable general purpose computing on GPUs (GPGPU) (e.g., GPUs 1022). In at least one embodiment, a software layer of parallel computing platform 1030 may provide access to virtual instruction sets and parallel computational elements of GPUs, for execution of compute kernels. In at least one embodiment, parallel computing platform 1030 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1030 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1018 may be leveraged to perform inferencing services for executing machine learning model(s) associated with applications (e.g., tasked with performing one or more processing tasks of an application). In at least one embodiment, AI services 1018 may leverage AI system 1024 to execute machine learning model(s) (e.g., neural networks, such as CNNs) for segmentation, reconstruction, object detection, feature detection, classification, and/or other inferencing tasks. In at least one embodiment, applications of deployment pipeline(s) 1010 may use one or more of output models 916 from training system 904 and/or other models of applications to perform inference on imaging data (e.g., DICOM data, RIS data, CIS data, REST compliant data, RPC data, raw data, etc.). In at least one embodiment, two or more examples of inferencing using application orchestration system 1028 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1028 may distribute resources (e.g., services 920 and/or hardware 922) based on priority paths for different inferencing tasks of AI services 1018.

In at least one embodiment, shared storage may be mounted to AI services 1018 within architecture 1000. In at least one embodiment, shared storage may operate as a cache (or other storage device type) and may be used to process inference requests from applications. In at least one embodiment, when an inference request is submitted, a request may be received by a set of API instances of deployment system 906, and one or more instances may be selected (e.g., for best fit, for load balancing, etc.) to process a request. In at least one embodiment, to process a request, a request may be entered into a database, a machine learning model may be located from model registry 924 if not already in a cache, a validation step may ensure appropriate machine learning model is loaded into a cache (e.g., shared storage), and/or a copy of a model may be saved to a cache. In at least one embodiment, the scheduler (e.g., of pipeline manager 1012) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 920 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1026, and an inference service may perform inferencing on a GPU.

In at least one embodiment, visualization services 1020 may be leveraged to generate visualizations for viewing outputs of applications and/or deployment pipeline(s) 1010. In at least one embodiment, GPUs 1022 may be leveraged by visualization services 1020 to generate visualizations. In at least one embodiment, rendering effects, such as ray-tracing or other light transport simulation techniques, may be implemented by visualization services 1020 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1020 may include an internal visualizer, cinematics, and/or other rendering or image processing capabilities or functionality (e.g., ray tracing, rasterization, internal optics, etc.).

In at least one embodiment, hardware 922 may include GPUs 1022, AI system 1024, cloud 1026, and/or any other hardware used for executing training system 904 and/or deployment system 906. In at least one embodiment, GPUs 1022 (e.g., NVIDIA's TESLA® and/or QUADRO® GPUs) may include any number of GPUs that may be used for executing processing tasks of compute services 1016, collaborative content creation services 1017, AI services 1018, simulation services 1019, visualization services 1020, other services, and/or any of features or functionality of software 918. For example, with respect to AI services 1018, GPUs 1022 may be used to perform pre-processing on imaging data (or other data types used by machine learning models), post-processing on outputs of machine learning models, and/or to perform inferencing (e.g., to execute machine learning models). In at least one embodiment, cloud 1026, AI system 1024, and/or other components of architecture 1000 may use GPUs 1022. In at least one embodiment, cloud 1026 may include a GPU-optimized platform for deep learning tasks. In at least one embodiment, AI system 1024 may use GPUs, and cloud 1026—or at least a portion tasked with deep learning or inferencing—may be executed using one or more AI systems 1024. As such, although hardware 922 is illustrated as discrete components, this is not intended to be limiting, and any components of hardware 922 may be combined with, or leveraged by, any other components of hardware 922.

In at least one embodiment, AI system 1024 may include a purpose-built computing system (e.g., a super-computer or an HPC) configured for inferencing, deep learning, machine learning, and/or other artificial intelligence tasks. In at least one embodiment, AI system 1024 (e.g., NVIDIA's DGX™) may include GPU-optimized software (e.g., a software stack) that may be executed using a plurality of GPUs 1022, in addition to CPUs, RAM, storage, and/or other components, features, or functionality. In at least one embodiment, one or more AI systems 1024 may be implemented in cloud 1026 (e.g., in a data center) for performing some or all of AI-based processing tasks of architecture 1000.

In at least one embodiment, cloud 1026 may include a GPU-accelerated infrastructure (e.g., NVIDIA's NGC™) that may provide a GPU-optimized platform for executing processing tasks of architecture 1000. In at least one embodiment, cloud 1026 may include an AI system(s) 1024 for performing one or more of AI-based tasks of architecture 1000 (e.g., as a hardware abstraction and scaling platform). In at least one embodiment, cloud 1026 may integrate with application orchestration system 1028 leveraging multiple GPUs to enable seamless scaling and load balancing between and among applications and services 920. In at least one embodiment, cloud 1026 may be tasked with executing at least some of services 920 of architecture 1000, including compute services 1016, AI services 1018, and/or visualization services 1020, as described herein. In at least one embodiment, cloud 1026 may perform small and large batch inference (e.g., executing NVIDIA's TensorRT™), provide an accelerated parallel computing API and platform 1030 (e.g., NVIDIA's CUDA®), execute application orchestration system 1028 (e.g., KUBERNETES), provide a graphics rendering API and platform (e.g., for ray-tracing, 2D graphics, 3D graphics, and/or other rendering techniques to produce higher quality cinematics), and/or may provide other functionality for architecture 1000.

In at least one embodiment, in an effort to preserve patient confidentiality (e.g., where patient data or records are to be used off-premises), cloud 1026 may include a registry, such as a deep learning container registry. In at least one embodiment, a registry may store containers for instantiations of applications that may perform pre-processing, post-processing, or other processing tasks on patient data. In at least one embodiment, cloud 1026 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two, but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
obtaining a first prompt for a responsive, to the first prompt, description of a media item;
processing, using a content detection model, the media item and a representation of the first prompt to obtain a characterization of the media item;
generating, using the first prompt and the characterization of the media item, a second prompt comprising an instruction to a language model (LM);
causing the LM to process the second prompt to generate a computing code associated with the characterization of the media item; and
causing the computing code to be executed to generate the responsive description of the media item.

2. The method of claim 1, wherein the first prompt comprises a natural language prompt.

3. The method of claim 1, wherein the representation of the first prompt comprises one or more keywords associated with the first prompt.

4. The method of claim 1, further comprising selecting, based on the representation of the first prompt, the content detection model from a plurality of trained models.

5. The method of claim 4, wherein the content detection model comprises an object detection model trained to detect one or more objects associated with the representation of the first prompt.

6. The method of claim 4, wherein the content detection model comprises an open vocabulary model comprising:
a computer vision portion to process at least the media item,
a language-comprehension portion to process at least the characterization of the media item, and
a classifier portion to process outputs of the computer vision portion and the language-comprehension portion to obtain the characterization of the media item.

7. The method of claim 1, wherein the media item comprises at least one of:
an image item,
a video item,
an audio item, or
sensor data item.

8. The method of claim 1, wherein the characterization of the media item comprises:
one or more bounding boxes for respective one or more objects in the media item.

9. The method of claim 1, wherein the instruction for the LM comprises:
a natural language explanation of a format of the characterization of the media item.

10. The method of claim 1, wherein the LM is trained to generate a computing code to perform a computing task responsive to a natural language instruction comprising a description of the computing task.

11. A system comprising:
one or more processing units to:
process, using a content detection model, a media item and a representation of a first prompt, corresponding to the media item, to obtain a characterization of the media item;
generate, using the first prompt and the characterization of the media item, a second prompt comprising an instruction to a language model (LM); and
cause the LM to process the second prompt to generate a computing code associated with the characterization of the media item, wherein the computing code, when executed, generates a responsive description of the media item for the first prompt.

12. The system of claim 11, wherein the representation of the first prompt comprises one or more keywords associated with the first prompt.

13. The system of claim 11, wherein the one or more processing units further to select, using the representation of the first prompt, the content detection model from a plurality of trained models.

14. The system of claim 13, wherein the content detection model comprises at least one of:
an object detection model trained to detect one or more objects associated with the representation of the first prompt; or
an open vocabulary model comprising:
a computer vision portion to process at least the media item,
a language-comprehension portion to process at least the characterization of the media item, and
a classifier portion to process outputs of the computer vision portion and the language-comprehension portion to obtain the characterization of the media item.

15. The system of claim 11, wherein the media item comprises at least one of:
an image item,
a video item,
an audio item, or
sensor data item.

16. The system of claim 11, wherein the characterization of the media item comprises:
one or more bounding boxes for respective one or more objects in the media item.

17. The system of claim 11, wherein the instruction for the LM comprises:
a natural language explanation of a format of the characterization of the media item.

18. The system of claim 11, wherein the LM is trained to generate a computing code to perform a computing task responsive to a natural language instruction comprising a description of the computing task.

19. The system of claim 11, wherein the system is comprised in at least one of:
an in-vehicle infotainment system for an autonomous or semi-autonomous machine;
a system for performing one or more simulation operations;
a system for performing one or more digital twin operations;
a system for performing one or more medical operations;
a system for performing one or more factory operations;
a system for performing one or more analytics operations;
a system for performing light transport simulation;
a system for performing collaborative content creation for 3D assets;
a system for performing one or more deep learning operations;
a system implemented using an edge device;
a system for generating or presenting at least one of virtual reality content, mixed reality content, or augmented reality content;
a system implemented using a robot;
a system for performing one or more conversational AI operations;
a system implementing one or more large language models (LLMs);
a system implementing one or more language models;
a system for performing one or more generative AI operations;
a system for generating synthetic data;
a system incorporating one or more virtual machines (VMs);
a system implemented at least partially in a data center; or
a system implemented at least partially using cloud computing resources.

20. A non-transitory computer-readable memory storing instructions thereon that, when executed by a processing device, cause the processing device to:
generate, using a first prompt and a characterization of a media item, a second prompt comprising an instruction to a language model (LM), the characterization of the media item obtained by applying the media item and the first prompt to at least one content detection model; and
cause the LM to process the second prompt to generate a computing code associated with the characterization of the media item, wherein invocation of the computing code generates a responsive description of the media item for the first prompt.
